(19) United States
(12) Patent Application Publication
(10) Pub. No.: US 2012/0095940 A1
(43) Pub. Date: Apr. 19, 2012

(54) PRICING MECHANISMS FOR PERISHABLE TIME-VARYING RESOURCES

(75) Inventors: Christian H. Borgs, Boston, MA (US); Utku Ozan Candogan, Cambridge, MA (US); Jennifer Tour Chayes, Boston, MA (US); Ilan Lobel, New York, NY (US); Hamid Nazerzadeh, Cambridge, MA (US)

(73) Assignee: Microsoft Corporation, Redmond, WA (US)

(21) Appl. No.: 12/903,227

(22) Filed: Oct. 13, 2010

(51) Int. Cl. G06F 17/00

(52) U.S. Cl. 705/400

(57) ABSTRACT

A price determination module (PDM) is described herein which defines price information for perishable resource items subject to variable supply and demand. The price information specifies pricing options for consideration by consumers. In one approach, the PDM provides a plurality of per-instant pricing options, where each pricing option defines a price for a resource item in a particular time instance. In another approach, the PDM provides a plurality of per-contract pricing options, where each pricing option defines a price for a resource item in a particular time segment. The PDM can determine the pricing options by formulating and solving an optimization problem, e.g., using a dynamic programming technique. The optimization problem can be constrained by either hard or soft capacity constraints.

### BACKGROUND

In some environments, a provider delivers resource items to consumers subject to variable supply and demand. That is, the provider's supply of resource items varies as a function of time. Further, the consumers' demand for the resource items changes as a function of time. Moreover, in some environments, the resource items are considered perishable in the sense that they must be consumed based on prescribed timing considerations, else they are effectively “lost.”

As used herein, the term resource item pertains to any good or service (or combination thereof) which confers some benefit to a consumer. In one environment, for example, a resource item can correspond to a seat on an airplane that an airline provider wishes to deliver to a consumer for a stated price. In another environment, a resource item may correspond to a computational resource provided by a data center. In both of these instances, the good or service that is provided is considered perishable because it will expire if not used by a specified time. For example, the airline provider cannot sell any seat on the airplane after the airplane leaves the runway. A data center cannot sell spare processing capacity when energy is no longer available to power the server computers of the data center.

A provider faces various challenges in assigning prices to its resource items in an environment having the above-described characteristics. The challenges ensue, in part, from the variability in supply, the variability in demand, the variability in job requests specified by individual consumers, and the ephemeral nature of the resource items themselves. To address these issues, a provider may resort to various simplified pricing structures. For example, a data center operator can charge a fixed fee to provide a specified amount of processing capacity, irrespective of the myriad issues described above. This approach, however, is not fully satisfactory. For instance, this approach may fail to provide satisfactory benefits to both consumers and the provider.

### SUMMARY

A task management module (TMM) is described herein for determining price information for perishable resource items, in one case, subject to variable supply and demand. The TMM operates by providing an objective function which defines utility as a function of price. More specifically, the objective function comprises a weighted combination of a consumer welfare component and a revenue component. The consumer welfare component defines a benefit conferred to a group of consumers of resource items and the revenue component defines a benefit conferred to the provider of the resource items. The TMM then solves an optimization problem that is formulated using the objective function, to provide price information. The price information specifies a plurality of pricing options for consideration by the consumers.

The TMM communicates the price information to at least one consumer. The TMM then receives a selection of a pricing option from the consumer. The TMM responds by allocating a resource item to the consumer in a manner governed by the pricing selection made by the consumer.

According to one illustrative aspect, the price information that is provided to the consumer comprises a plurality of per-instance prices corresponding to a respective plurality of time instances. That is, each per-instance price defines a cost for providing a resource item in a corresponding time instance.

According to another illustrative aspect, the price information that is provided to the consumer alternatively comprises a plurality of per-contract prices corresponding to a plurality of time segments. That is, each time segment generally defines a time at which a task associated with a resource item is submitted and a time at which the resource item is to be delivered. Each per-contract price defines a cost for providing the resource item commensurate with the timing constraints specified in a corresponding time segment.

According to another illustrative aspect, the objective function is defined with respect to a hard capacity constraint which specifies that the provider is not to exceed its capacity to deliver resource items.

According to another illustrative aspect, the objective function is defined with respect to a soft capacity constraint which specifies that the provider incurs an increased cost if it exceeds its capacity.

According to another illustrative aspect, the solving technique used to solve an optimization problem comprises a mathematical programming technique.

According to another illustrative aspect, the solving technique comprises a dynamic programming technique. For instance, the dynamic programming technique involves successively breaking down an initial time segment into different sub-segments to successively identify the prices that make up the pricing information. At each stage, the TMM can process a sub-segment in a manner which is decoupled from the processing of other sub-segments.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative environment in which price information is determined and conveyed to consumers. The price information specifies prices for perishable resource items, subject to variable supply and demand.

FIG. 2 shows an illustrative data center environment, which represents one of many applications of the functionality shown in FIG. 1.

FIG. 3 is a graphical depiction of concepts associated with a per-instance pricing scheme.

FIG. 4 is a graphical depiction of concepts associated with a per-contract pricing scheme.

FIG. 5 shows a task management module (TMM) for use in the environment of FIG. 1. The TMM determines the price information and manages the allocation of resource items in accordance with the price information.

FIG. 6 is a graphical depiction of concepts associated with an objective function that specifies a weighted combination of consumer welfare (CW) and provider revenue (REV).

FIG. 7 is a flowchart that describes one overall manner of operation of the TMM shown in FIGS. 1 and 5.

FIG. 8 is a flowchart that describes one manner of determining price information by formulating and solving an optimization problem.

FIG. 9 is a graphical depiction of concepts associated with a dynamic programming technique that is used to solve the optimization problem.

FIG. 10 provides additional illustrative detail regarding the dynamic programming technique introduced in FIG. 9.

FIGS. 11 and 12 are flowcharts that describe the manner of operation of the dynamic programming technique shown in FIGS. 9 and 10.

FIG. 13 is a flowchart that describes one manner of determining a set of possible prices.

FIG. 14 shows illustrative processing functionality that can be used to implement any aspect of the features shown in the foregoing drawings.

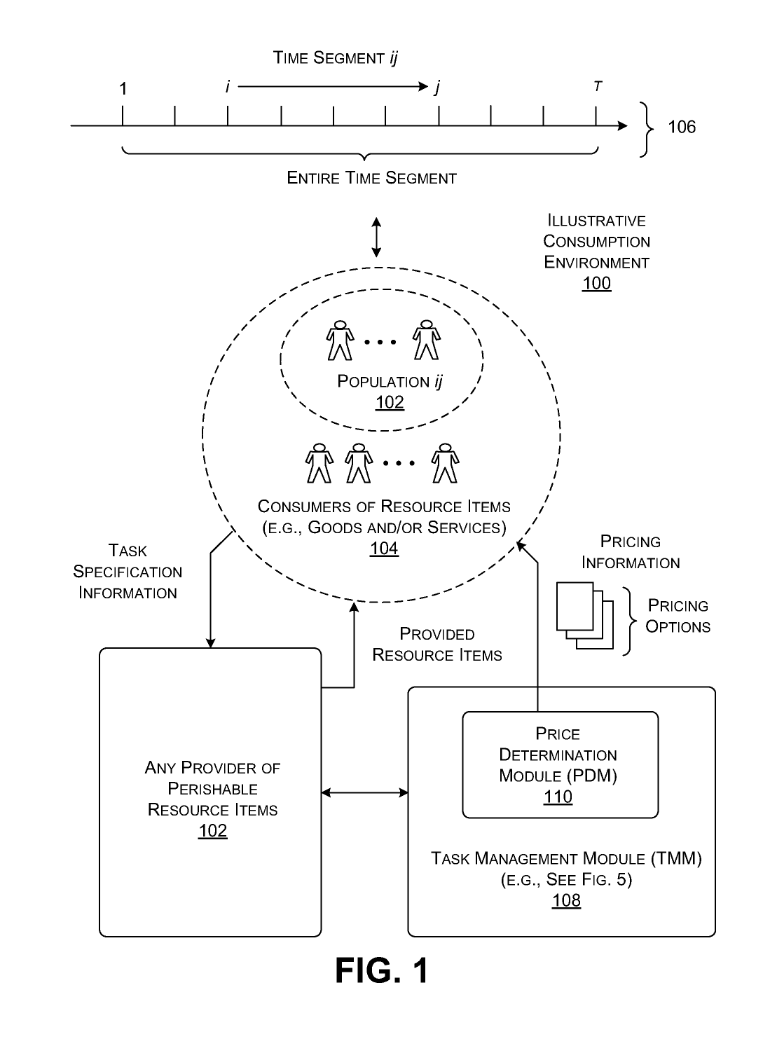

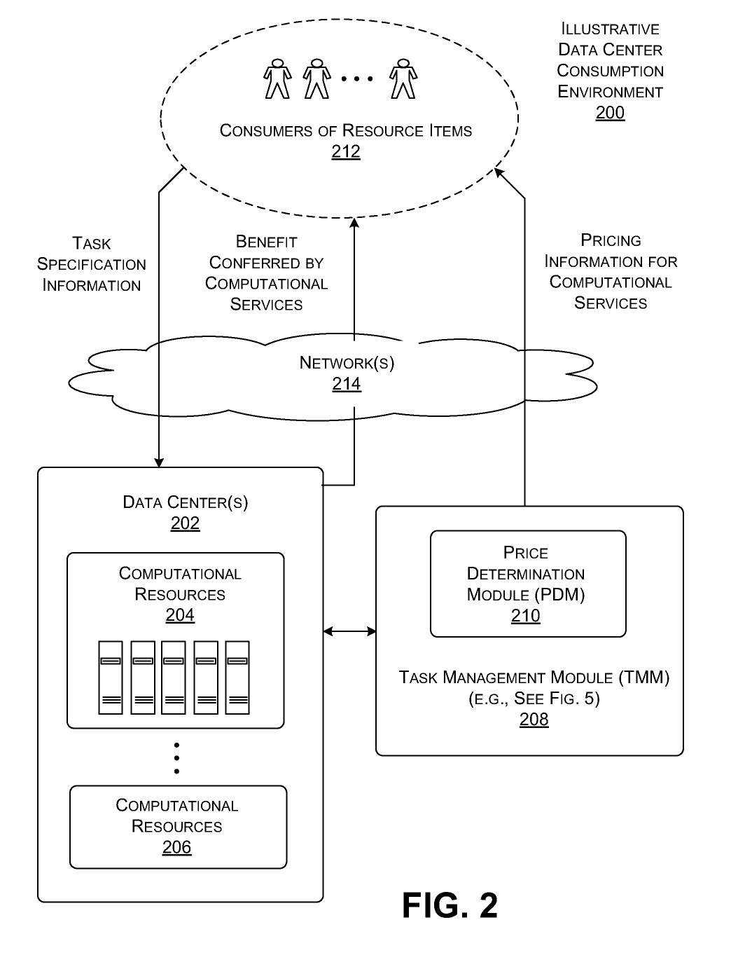

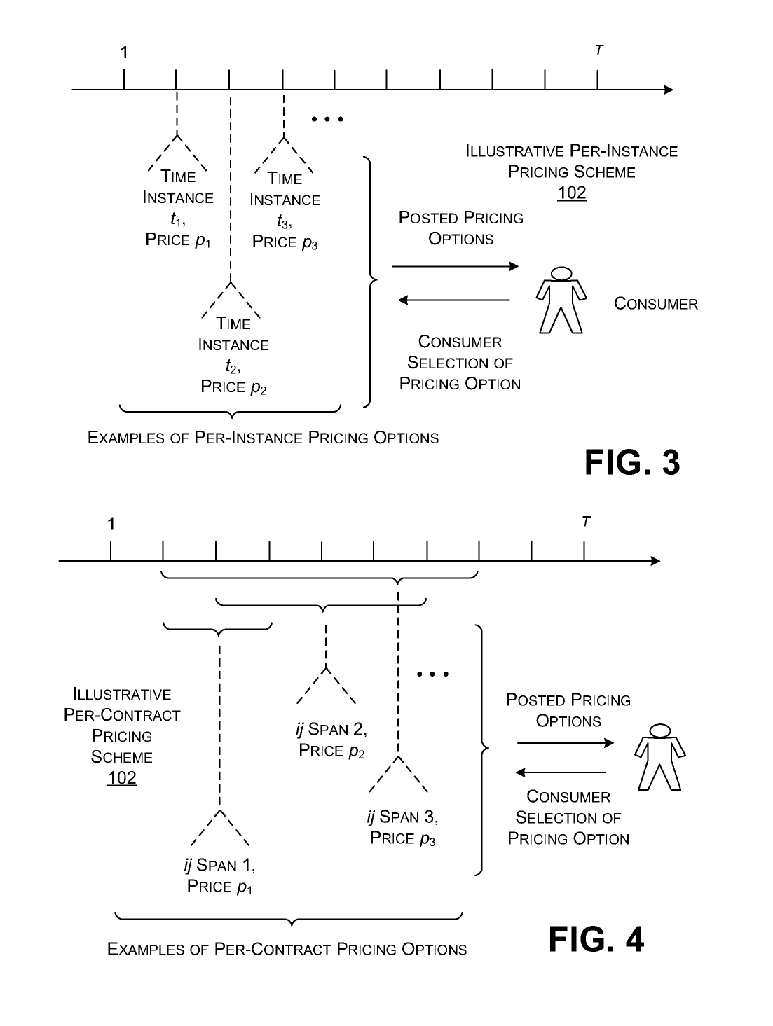

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative task management module for determining price information that governs the consumption of perishable resource items, subject, in some cases, to variable supply and demand. Section B describes illustrative methods which explain the operation of task management module of Section A. Section C describes illustrative processing functionality that can be used to implement any aspect of the features described in Sections A and B.

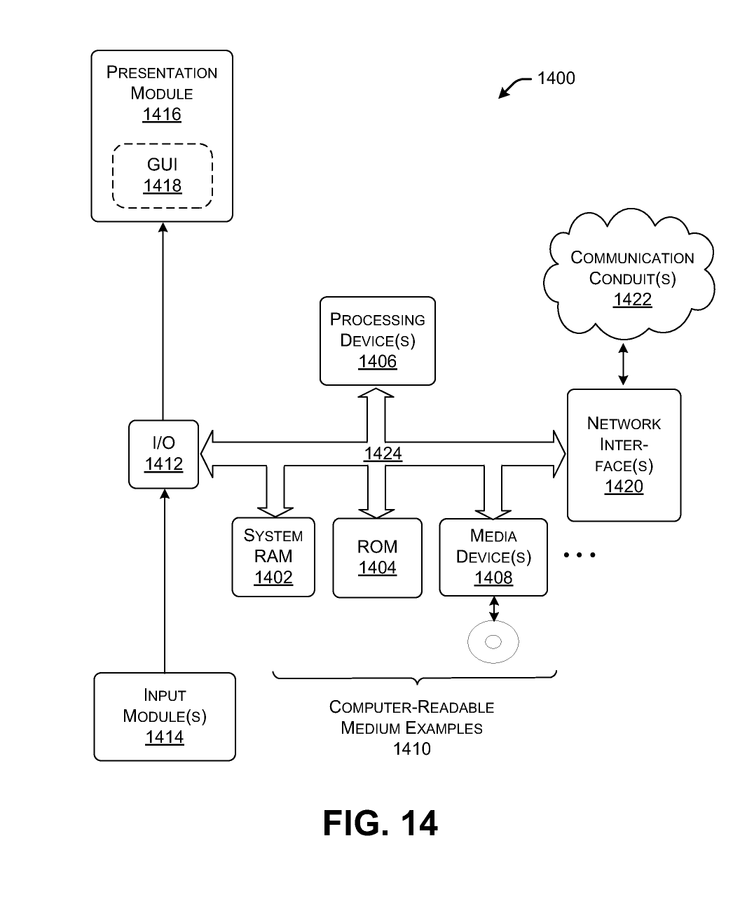

As a preliminary matter, some of the figures describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 14, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

A. Illustrative Task Management Functionality

FIG. 100 describes one possible environment 100 in which perishable resource items are supplied to consumers who request these resource items, subject to plural pricing options conveyed to the consumers. A provider refers to any entity (or group of entities) that is entrusted to provide the resource items. A consumer refers to any entity (or group of entities) that consumes the resource items. In one case, an entity may correspond to a person or plural person. Alternatively, or in addition, an entity can correspond to a non-human agent of any type, such as a functional component within a system that request and receives resource items.

As used herein, a resource item corresponds to any tangible or intangible benefit conferred to a consumer. For example, a resource item may correspond to a physical good of any nature. Alternatively, or in addition, a resource item may correspond to service of any nature. In one context, the resource item may be perishable. As described above, a resource item is perishable insofar it will expire if not used according to prescribed timing considerations. Once expired, the perishable resource item cannot be consumed.

To cite a few examples, a provider may provide rights to a consumer with respect to some event that occurs at a specified time (or times). For example, a provider may provide a ticket to a user for a concert or sporting event, an airline flight, and so on. Once the event happens, the resource item simply no longer exists, and therefore cannot be consumed. In another case, a provider may provide rights to a consumer with respect to some resource item that physically degrades over time. In another case, a provider may provide rights to a consumer with respect to some resource item that becomes unusable over time due to collateral issues. For example, a provider associated with a data center may provide computational resources to a consumer so long as power is available to operate those computational resources. These examples are representative, rather than exhaustive; other interpretations of the term “perishable resource item” are possible.

Further, the environment 100 may provide the resource items to consumers subject to variable supply and variable demand. This means that the provider has a capacity to deliver resource items to consumers, and that capacity may vary over time. Further, the consumers express demand for the resource items, and that demand may likewise vary over time. Consider, for example, a provider associated with a data center. The data center may have a limited number of server computers to deliver computational resource items to consumers, and a limited amount of energy to power the server computers. The availability of computational resource items may change over time as different computer servers are enabled and disabled for various reasons; further, the availability of computational resource items varies with the changing availability of energy used to power the resource items. Further, in this environment, the consumers may modulate their requests for computational resource items based on any combination of time-varying factors, such as time-of-day considerations, season-related considerations, business-related considerations of any nature, and so on.

FIG. 1 illustrates an illustrative provider 102 and a population of consumers 104. In one case, the provider may correspond to physical infrastructure for providing goods and/or services, such as a manufacturing plant of any type, a data center, and so on. Alternatively, or in addition, the provider may more generally correspond to a framework or paradigm which accommodates the delivery of resource items to consumers. For example, the provider can correspond to an employment agency that provides human workers which provide services to consumers.

The population of consumers can encompass human entities and/or non-human entities having diverse resource needs. Generally stated, some of the consumers may express their resource needs in the context of a time horizon ( [symbol] ) 106, defining an entire time segment which begins at time instance 1 and ends at time instance T. For example, the time horizon 106 may correspond to a day, and the time instances in that time horizon 106 can correspond to hours within the day. Or the time horizon 106 may correspond to a week and the time instances within that time horizon 106 may correspond to days within the week, and so on. Other interpretations of the time horizon and the time instances are possible. Generally stated, a time instance t corresponds to a sub-interval within the entire time segment having any length.

A consumer may specify his or her resource needs with respect to two time instances, i.e., time instance i and time instance j. As used herein, the time instance i corresponds to the consumer's time of “arrival” into the environment 100. The time of arrival, in turn, can be defined in different ways in the context of different respective environments. For example, in one environment, the time instance i may correspond to the time at which the consumer submits his or her request to the provider.

The time period j corresponds to the deadline that the consumer specifies for a task. Again, the deadline can be interpreted in different ways in the context of different respective environments. For example, in one environment, the time instance j corresponds to the time at which the consumer needs a resource items. And thus, the time instance j corresponds to the time instance by which the provider promises to deliver the resource item.

This interval, ij, defines a sub-segment within the entire time segment (1, T). The consumer who specifies the interval ij may be a member of a group of other consumers who specify the same i and j. This group is referred to herein as population ij. The consumers in population ij have a delay sensitivity defined by difference in time between j and i. Accordingly, the entire population of consumers can be conceptualized as a set of sub-populations associated with different respective sub-segments defined by respective i's and j's.

Further, this explanation uses the notation aᵢⱼ to refer a mass (e.g., a portion) of the population ij that has a delay sensitivity defined by i and j. Accordingly, the mass of all populations arriving at time instance i is given by aᵢ=Σⱼaᵢⱼ. In one implementation, the mass of consumers aᵢ arriving at time instance i is assumed to be known, e.g., based on historical demand information (to be described in greater detail below). The mass of consumers aᵢⱼ for population ij can be determined based on aᵢ and known distributions of delay sensitivities.

A task management module (TMM) 108 interacts with the provider 102 to manage the delivery of resource items to consumers who request the items. To perform this role, the TMM 108 uses a price determination module (PDM) 110 to determine price information. The price information defines the prices associated with the resource items. More specifically, the PDM 110 can formulate the price information in terms of a plurality of pricing options. Each pricing option specifies a promise to deliver a resource item to a consumer based on a specified timing constraint, for a specified price. For example, as will be described below, the PDM 110 can formulate the pricing options using a per-instance pricing scheme and/or a per-contract pricing scheme.

In general, the PDM 110 generates the pricing options to satisfy a utility-related performance goal. For example, as will be described in detail below, the PDM 110 can formulate an objective function that expresses the overall utility conferred to the environment 100 as a function of price. The PDM 110 can then solve an optimization problem that is formulated based on the objective function, to provide price information which satisfies the utility-related performance goal. The price information provides prices that can be considered optimal. However, the term “optimal” is used liberally herein; it describes prices that satisfy a stated goal to any extent, which may correspond to the best solution in this regard, or one of a plurality of solutions deemed acceptable based on any criterion (or criteria).

As will be described in greater detail below, the objective function may correspond to a weighted welfare function. The optimization problem involves finding the prices which maximize this weighted welfare function. The weighted welfare function includes a welfare component which describes benefits conferred to the consumers, and a revenue component which describes benefits conferred to the provider.

The consumers who receive the pricing options study these options in view of their individual resource needs. The consumers then select respective pricing options that are deemed to adequately satisfy their individual needs. The behavior of the consumers in this regard is explained in greater detail below. The consumers may convey their pricing selections to the TMM 108, either directly or indirectly. More generally, the consumers convey task specification information to the TMM 108. The task specification information describes the pricing selections, along with other potential job specification information.

The TMM 108 responds to the task specification information by allocating the resource items, if possible, in a manner which satisfies the task specification information. This may involve scheduling or otherwise orchestrating the manner in which the provider generates and delivers the resource items. The provider then generates and delivers the resource items to the consumers in a manner directed by the allocation. Delivery can be accomplished in different ways, e.g., depending on the nature of the resource items; hence the term “delivery” has broad connotation as used herein.

In one implementation, the provider 102 can correspond to one or more computing systems, provided at one site or distributed over a plurality of sites. The TMM 108 can likewise be implemented as one or more computing systems, provided at one site or distributed over a plurality of sites. Any consumer may operate a user device (not shown) of any type, such as a personal computer, a workstation, a mobile computing device of any type, a game console device, a set-top box device, and so on. The user devices may communicate with the provider 102 and/or directly with the TMM 108 via one or more networks. The network(s) can be implemented using any combination of wireless links, hardwired links, routing functionality, gateway functionality, name server functionality, etc. The network(s) can be governed by any protocol or combination of protocols.

In an alternative implementation, the TMM 108 can allocate resources in manual fashion, at least in part. For example, the TMM 108 can receive oral or written requests from the consumers and can allocate resource items based on those requests. In addition, the TMM 108 can communicate its allocation instructions to the provider in manual fashion, at least in part.

FIG. 2 shows a data center consumption environment 200 which represents one application of the functionality shown in FIG. 1. Here, a provider of one or more data centers 202 (referred to in the singular below) provides one or more collections (204, . . . 206) of computational resources. For example, the computational resources may correspond to server computers, data stores, network functionality, and so on. The computational resources confer a time-varying amount of processing resources, memory (storage) resources, bandwidth resources, and so on, or any combination thereof.

A task management module (TMM) 208 may use a price determination module (PDM) 210 to define price information that provides different pricing options. The TMM 208 can then convey the price information to a population of consumers 212. The consumers may select respective pricing options which suit their respective needs. The consumers then convey task specification information to the data center 202 and/or directly to the TMM 208. The task specification information conveys the selected pricing options as well as, optionally, other information regarding the tasks to be performed. For example, the task specification information can convey Service Level Agreement (SLA) information which specifies other characteristics of the consumers' processing needs.

In the same manner described with respect to FIG. 1, the data center 202 of FIG. 2 can correspond to one or more computing systems, provided at one site or distributed over a plurality of sites. The TMM 208 can likewise be implemented as one or more computing systems, provided at one site or distributed over a plurality of sites. Any consumer may operate a user device (not shown) of any type to communicate with the data center 202 and/or directly with the TMM 208. The user devices may communicate with the data center 202 and/or directly with the TMM 208 via one or more networks 214 (referred to in the singular below). For example, the network 214 may correspond to a wide area network (e.g., the Internet), a local area network, or some combination thereof.

FIGS. 3 and 4 describe different pricing schemes by which the PDM 110 (of FIG. 1) can define pricing options. More specifically, FIG. 3 describes a per-instance pricing scheme 302 and FIG. 4 describes a per-contract pricing scheme 304.

Starting with FIG. 3, the PDM 110 defines a plurality of pricing options associated with different time instances within the time horizon (1, T). That is, each pricing option in this scheme defines a time instance and a corresponding price. That price defines the cost of a resource item, providing that the resource item is provided within the corresponding time instance. For example, assume that a pricing option specifies the time instance of Wednesday and a price of ten dollars. That price defines the cost to a consumer for the resource item, providing that the consumer selects this option. If selected, the TMM 108 then generates and delivers the resource item on Wednesday.

Generally, a consumer can review these per-instance pricing options with his or her resource needs in mind The consumer can then select a pricing option that best satisfies his or her needs, as assessed by the consumer.

In some cases, the consumer may have resource needs that span plural time instances. According to one implementation, the consumer may address this issue by selecting as many pricing options as is deemed appropriate to satisfy his or her resource needs. For example, if the consumer determines that three days are appropriate to provide a resource item, the consumer can select pricing options associated with three consecutive days (although the days need not be consecutive). The PDM 110 may assign different prices to these different days, which means that the consumer will incur different respective costs for the three days.

In FIG. 4, the PDM 110 defines a plurality of pricing options associated with different time segments within the time horizon (1, T). That is, each pricing option in this scheme defines a time segment ij and a corresponding price. More specifically, a time segment is defined with respect a starting time instance i and an ending time instance j. In one environment, the starting time instance i, referred to as the time of arrival, may correspond to a time at which the consumer submits his or her resource request to the provider (and/or directly to the TMM 108). The ending time instance j may correspond to a time at which the consumer will receive the resultant resource item from the provider. According to one approach, the provider will provide the resource item at time instance j even if it happens have the ability to deliver it sooner. For example, assume that a pricing option specifies a time segment of i=Wednesday and j=Saturday for a particular week, for a price of twenty dollars. That price defines the cost to a consumer for the resource item, assuming the consumer selects this option. If selected, the TMM 108 receives a resource request on Wednesday and delivers the resource item on Saturday, regardless if it can be delivered sooner.

Again, a consumer can review these per-contract pricing options with his or her resource needs in mind. The consumer can then select a pricing option that best satisfies his or her needs, as assessed by the consumer.

More generally, in both the scenarios of FIG. 3 and FIG. 4, the PDM 110 defines the prices to achieve a desired utility-related goal (to be described below in greater detail). In the case of the per-contract pricing scheme, the PDM 110 defines the prices in such a manner that the consumers are encouraged to accurate convey the nature of their resource needs. This will prevent consumers from “gaming” the TMM 108. For example, assume that a consumer is actually willing to wait an entire week to receive a resource item. Hence, the consumer may wish to select a pricing option that specifies an ij time segment of i=Monday and j=Friday, at a specified cost. But if the consumer notices that a time segment from Wednesday to Friday has a lower cost, the consumer will opt to select that time segment, even though this timeframe does not actually reflect the true level of urgency of his or her task. The TMM 108 selects the prices to rule out these types of gaming decisions, and thereby incentivize the consumers to accurately convey their resource needs. This feature, in turn, results in efficiencies that confer benefits to both the consumers and the provider.

The pricing schemes shown in FIGS. 3 and 4 are representative rather than exhaustive. Other environments may define other ways of partitioning the entire time segment into different sub-segments, and then for assigning prices to those sub-segments.

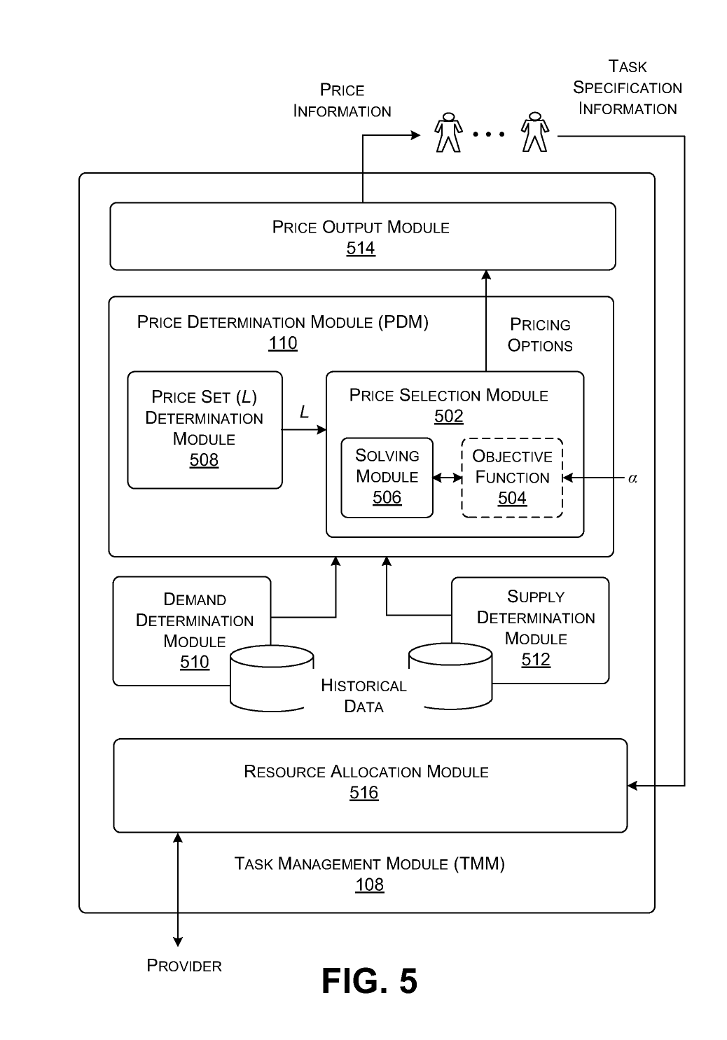

FIG. 5 shows one possible implementation of the task management module (TMM) 108 of FIG. 1. The functionality shown in FIG. 5 can be provided by any computing system or plural computing systems, provided at a single site or distributed among plural sites.

As shown in both FIGS. 1 and 5, the TMM 108 includes a price determination module (PDM) 110. The PDM 110 determines pricing options, e.g., corresponding to the per-instance pricing option shown in FIG. 3 or the per-contract pricing option shown in FIG. 4. In one approach, the PDM 110 performs this task using a price selection module 502. The price selection module 502 formulates an objective function 504 which mathematically describes a utility-related objective to be achieved, as a function of price. A solving module 506 then solves an optimization problem that is formulated based on the objective function 504. It performs this task using any type of solving technique, such as a mathematical programming technique or a dynamic programming technique. Section B provides illustrative details regarding one type of dynamic programming technique that can be used to solve an optimization problem that is formulated based on the per-instance pricing scheme. As a result of its processing, the solving module 506 outputs pricing information (and corresponding prices) that solves the optimization problem, namely, pricing information that maximizes the utility specified by the objective function 504.

The price selection module 502 depends on various inputs to formulate an optimization problem based on the objective function 504. For example, the price selection module 502 selects the prices specified in the pricing options from a set L of possible prices. A price set determination module 508 uses one or more techniques to define the set L of possible prices. For example, in the case of a hard capacity constraint, the price set determination module 508 defines possible prices based on capacity constraints that may affect the provider at each time instance within the time horizon. Additional details regarding the operation of the price set determination module 508 are provided below (in Section B).

The price selection module 502 also selects the prices as a function of demand information, provided by a demand determination module 510. The demand information specifies the resource needs of consumers for each time instance within the time horizon. More specifically, the demand information can quantify the value that the consumers place on resource requests that they submit to the provider, expressed by valuation v. In addition, or alternatively, the demand information can express the delay sensitivities that consumers associate with their resource requests. In some cases, the valuations and delay sensitivities may be correlated.

In one case, the demand determination module 510 can formulate the demand information based on analysis of historical levels of demand, based, in part, on prior pricing selections made by consumers. For example, assume that the demand determination module 510 seeks to determine the demand for a resource item within a particular timeslot on a particular day (that has yet to occur). The demand determination module 510 can use any type of demand estimation technique to estimate this demand based historical demand information which is germane to the identified timeslot. In many cases, this is possible because the demand for resource items is cyclical or otherwise predictable to some extent.

The price selection module 502 also selects the prices as a function of supply information, provided by a supply determination module 512. The supply information specifies the resource capacity of the provider for each time instance within the time horizon. In one implementation, the supply determination module 512 makes the simplifying assumption that the supply (e.g., capacity cₜ) within a particular time instance t is constant. For example, in a data center environment, the supply determination module 512 provides supply information which reflects the time-varying availability of power sources and computing resources. In one case, the supply determination module 512 can use any supply estimation technique that predicts supply information based on historical capacity information. Again, in many cases, this is possible because the supply of resource items is cyclical or otherwise predictable to some extent.

A price output module 514 conveys the price options to consumers in any format through any delivery mechanism. For example, the price output module 514 can post the price options to a network-accessible site. Alternatively, or in addition, the price output module 514 can use a push technique to directly convey the pricing options to subscribing consumers, e.g., by sending a data file to the consumers that specifies the pricing options.

A resource allocation module 516 receives the pricing selections made by the consumers. The resource allocation module 516 then determines the manner in which resource items are to be provided to the consumers based on their pricing selections, e.g., by defining a schedule that sets forth the manner of generating and delivering the resource items. The resource allocation module 516 can then interact with the provider to actually generate and deliver the resource items in accordance with the schedule.

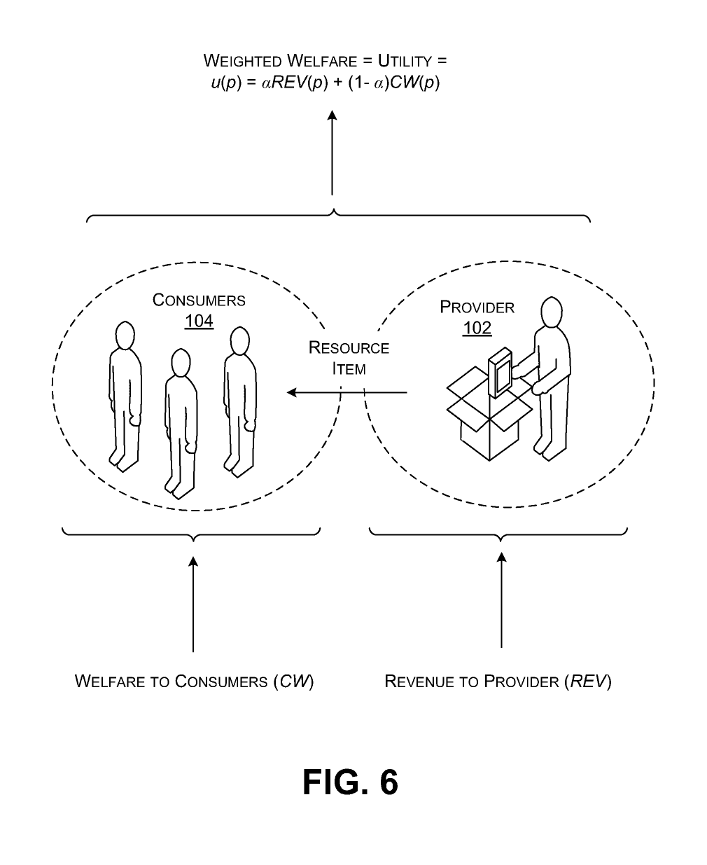

FIG. 6 shows a graphical depiction which sets forth high-level concepts regarding the objective function described above. In one case, the objective function corresponds to a function that specifies a utility-related benefit conferred to an environment 100. The benefit may have two components that are reflected by corresponding components within the objective function. A consumer welfare component (CW) describes a benefit conferred to the consumers 104 as a function of price. A revenue component (REV) describes a benefit conferred to the provider 102 as a function of price.

More specifically, the objective function specifies a weighted combination of the consumer welfare (CW) and the revenue (REV). A weighting parameter (α) defines the influence of each component in the objective function. If α equals 1, then the objective function will define utility solely on the basis of revenue provided to the provider. If α equals 0, then the objective function will define utility solely on the basis of benefit conferred to the consumers. For an α that lies somewhere between 0 and 1, the objective function will place some weight on the benefit conferred to the provider and some weight on the benefit conferred to the consumers. In the particular case of α=0.5, the objective function captures the case of social welfare, where the benefits conferred to the provider and consumers are given equal importance. By maximizing social welfare, the TMM 108 can be said to maximize the total value generated in the environment 100; this may lead to an increase in long-term profits.

More formally stated, the demand that a consumer places on a resource item can be expressed as valuation v. Assuming that the price of the resource item is p, then the consumer with valuation v receives a utility of v−p. In one implementation, the PDM 110 can normalize the valuations and prices so that they each vary from 0 to 1.

The following explanation makes the assumption that consumers are utility maximizers, so that no consumer will request a resource item if the price is higher than its valuation. For instance, if the provider offers a price p, then only consumers with valuation v≧p will request the resource item at that price p. Further, assume that a consumer can accommodate receipt of the resource item at different prices that are smaller than its valuation. That consumer will choose the lowest price. This may require the consumer to delay receipt of the resource item to receive the lowest price. And finally, if there are multiple lowest prices, it is assumed that the consumer will choose the first time instance at which the lowest price occurs.

The terms fᵢⱼ(v) refers to the distribution of valuations of consumers in a population ij. The TMM 108 can determine this information, in turn, based on historical demand information using the demand determination module 510 of FIG. 5. The corresponding cumulative distribution Fᵢⱼ for population ij can be found by integrating the term fᵢⱼ. The mass of all consumers that belong to the population ij that has a valuation larger than v can be given by aᵢⱼ(1−Fᵢⱼ(v)), where aᵢⱼ refers to a mass of the population ij.

With the above introduction pertaining to presumed behavior of consumers, the consumer welfare for a unit mass of consumers belonging to the population ij can be expressed by the following equation:

CWᵢⱼ(p)=∫ₚ¹(x−p)fᵢⱼ(x)dx.

And the revenue of the provider, for population ij, can be expressed by the equation:

REVᵢⱼ(p)=∫ₚ¹pfᵢⱼ(x)dx.

In these expressions, p represents the price of the resource item. The variable x within the integrals receives different valuations of consumers. More specifically, the integral is taken from price p to 1; this is because only consumers with valuations larger than p will request the resource item at price p. The term fᵢⱼ(x) refers to the distribution of valuations of consumers in the population ij, as described above.

In other words, REVᵢⱼ, referred to as the revenue component herein, represents the maximum revenue that the provider can extract from a unit mass of population ij at price p. CWᵢⱼ, referred to as the consumer welfare component herein, represents the corresponding aggregate utility of a consumer in the population ij. A weighted welfare function can be expressed by forming a weighted combination of the revenue component and the consumer welfare component, as follows:

u_{ijα}(p)=αREVᵢⱼ(p)+(1−α)CWᵢⱼ(p).

The term u_{ijα}(p) is also referred to as utility herein, referring to the utility conferred to the environment 100 as a whole. In this expression, α defines the weighting parameter, which, as said, can vary between 0 and 1. Note that for α=1, the utility is entirely based on the revenue component, and for α=1, the utility is entirely based on the consumer welfare component. For α=0.5, the utility captures the case of social welfare.

The above-described utility function can be further formulated to express the per-instance pricing scheme or the per-contract pricing scheme. Moreover, within each pricing scheme, the utility function can be customized to express a situation in which a hard capacity constraint applies, or a situation in which a soft capacity constraint applies. In the former case, the provider is considered to incur a cost γₜ for providing a unit amount of the resource item at time instance t, and furthermore, the provider is not allowed to exceed its processing capacity. In the case of a soft capacity constraint, the provider incurs a cost γₜ for processing a unit amount of the resource item at time instance t, and furthermore, the provider incurs a cost μₜ>γₜ per unit amount that the provider exceeds its capacity.

First, the following explanation sets forth one manner in which the PDM 110 can formulate the objective function for the case of the per-instance pricing scheme. By way of introduction, a consumer of population ij, being a utility maximizer, requests service at time t only if the price at time t, i.e., pₜ, is less than or equal to its valuation and t is such that i≦t≦j and pₜ≦pₖ for all k ∈ {i, i+1, . . . j}. As explained above, if there are multiple time instances t that satisfy i≦t≦j and pₜ≦pₖ, it is assumed that consumers in the population ij gets the resource item at the earliest such time instance, e.g., at the time instant defined by {t|i≦t≦j, pₜ≦pₖ, for all k ∈ {i, i+1, . . . j}}. The time instance t at which the consumer opts to receive the resource item is referred to herein as the exit time of the population ij (in which the consumers of this population can be considered to “leave” the TMM 108, e.g., insofar as they have met their resource needs and are no longer being managed by the TMM 108).

For a given price vector p, indicator variables 1ᵢⱼ(t, p) can be defined to indicate the exit time of population ij. The indicator variables can be expressed as:

$${1}_{ij} ( \hat{t} , p ) = \{ \begin{matrix}1 , & \hat{t} = min \{ \begin{matrix}t \vert i \leq t \leq j , {p}_{t} \leq {p}_{k} , \\ for all k ∈ \{ i , i + 1 , … j \}\end{matrix} \} \\ 0 , & otherwise .\end{matrix}$$

Using these indicator variables, the mass of population ij exiting the system at time t (under price vector p) can be expressed by:

rᵢⱼₜ(p)=aᵢⱼ1ᵢⱼ(t, p).

Similarly, the total amount of the population exiting the system at time t can be expressed as follows:

$${r}_{t} ( p ) = {\sum }_{i , j} {r}_{ijt} ( p ) .$$

For the case of hard capacity constraints, to repeat, the provider sets prices such that its capacity is not exceeded. Due to this constraint, the set of feasible prices that can be offered by the provider, denoted here as P, takes the following form:

$$𝒫 = \{ p \vert 0 \leq {p}_{t} \leq 1 and {\sum }_{ij \vert i \leq t \leq j} {r}_{ijt} ( p ) ( 1 - {F}_{ij} ( {p}_{t} ) ) \leq {c}_{t} , for all t \} .$$

In the optimal per-instance pricing scheme with hard capacity constraints, the provider posts prices so as to maximize the aggregate weighted welfare subject to the feasibility constraints defined above. More specifically, the optimization problem for this situation can be expressed as:

$${max}_{p ∈ 𝒫} {\sum }_{ijt} {r}_{ijt} ( p ) ( {u}_{ij α} ( {p}_{t} ) - α {y}_{t} ( 1 - {F}_{ij} ( {p}_{t} ) ) ) .$$

In the case of soft capacity constraints, all the prices in the set {p|0≦pₜ≦1 for all t ∈ T} are feasible. But the provider incurs additional charges when it exceeds capacity, which, in turn, decreases the profitability of the provider. Using the same approach as set forth above (for the hard capacity case), the optimization problem for the soft utility case can be expressed as:

$${max}_{\{ p \vert 0 \leq {p}_{t} \leq 1 \}} {\sum }_{ijt} {r}_{ijt} ( p ) ( {u}_{ij α} ( {p}_{t} ) - α {γ}_{t} ( 1 - {F}_{ij} ( {p}_{t} ) ) ) - α {\sum }_{t} {{μ}_{t} ( ( {\sum }_{ij} {r}_{ijt} ( p ) ( 1 - {F}_{ij} ( {p}_{t} ) ) ) - {c}_{t} )}^{+} .$$

Here, the term u_{ijα}(p) captures the total weighted welfare obtained from the population ij, γₜ Σᵢⱼrᵢⱼₜ(p)(1−Fᵢⱼ(p)) captures the cost of processing incurred at time t, and μₜ(Σᵢⱼrᵢⱼₜ(p)(1−Fᵢⱼ(p))−cₜ)⁺ captures the additional charges incurred due to the violation of the capacity constraints. The “+” superscript means that the associated parenthetical expression is constrained to positive values. That is, if the parenthetical expression evaluates to a negative value, then the expression is assigned the value 0; if the parenthetical expression evaluates to a positive value, then the expression is assigned its actual positive value.

Having defined the utility function, the solving module 506 then proceeds to solve it. In this context, the operation of solving corresponds to finding the price information that maximizes the utility, as defined by the weighted utility functions set forth above.

Now advancing to the per-contract pricing mechanism, the provider in this case posts a menu of contracts { [symbol] ᵢⱼ}_{i≦j|i,j∈} [symbol] , with corresponding prices {pᵢⱼ}_{i≦j|i,j∈} [symbol] . The provider asks all consumers purchasing contract [symbol] ᵢⱼ to submit their resource requests at time i. The provider then commits to return the resource item at time j. Further, it is assumed that, even if the provider can return the resource item at an earlier time, it nevertheless returns the resource item at time j. Hence, a consumer belonging to population kl can purchase a contract [symbol] ᵢⱼ only if k≦i≦j≦l. Since the consumers are utility maximizers, a consumer who belongs to population kl and requests a resource item, purchases the lowest-priced available contract.

Moreover, the PDM 110 guarantees that pᵢⱼ≦pₖₗ for i,j,k,l such that i≦k≦l≦j. This consideration is referred to herein as the incentive compatibility condition. Less formally stated, this condition achieves the benefit described above; namely, it prevents consumers from “gaming” the system by choosing contracts that do not express the true urgency of their resource needs.

The optimization problem for the case of the per-contract pricing mechanism is formulated in the manner specified below (for both hard and soft capacity constraints). To begin with, note that the main difference between the per-contract pricing mechanism and the per-instance pricing mechanism is that the provider now chooses the time at which it processes the consumer's request. Let dᵢⱼₜ denote the total mass from population ij that is scheduled by the pricing scheme at time t. Assuming that the provider maximizes the aggregate weighted welfare defined above, the problem of choosing the optimal contract can be expressed as:

$${max}_{p , \{ {d}_{ijt} \}} {\sum }_{ij} {u}_{ij α} ( {p}_{ij} ) ( 1 - {F}_{ij} ( {p}_{ij} ) ) {a}_{ij} - α {\sum }_{ijt} {y}_{t} {d}_{ijt} - α {\sum }_{t} {{μ}_{t} ( {\sum }_{i , j \vert i \leq t \leq j} {d}_{ijt} - {c}_{t} )}^{+}$$

such that:

$${\sum }_{t \vert i \leq t \leq j} {d}_{ijt} = ( 1 - {F}_{ij} ( {p}_{ij} ) ) {a}_{ij} for all i \leq j , \\ 0 \leq {p}_{ij} \leq {p}_{kl} for all i \leq \leq l \leq k \leq j , and$$

$$0 \leq {d}_{ijt} for all i \leq j .$$

This optimization problem applies to the case of hard capacity constraints when μₜ=∞. Otherwise, the optimization problem applies to the case of soft capacity constraints.

Further, given a price p, the corresponding demand can be obtained as 1−F(p). Thus, the inverse demand function, which maps the demand (q) to the corresponding price (p) can be given by p=F⁻¹(1−q). Based on these observations, the above optimization problem can be reformulated in the demand space as:

$${max}_{q , \{ {d}_{ijt} \}} {\sum }_{ij} {a}_{ij} {u}_{ij α} {q}_{ij} ( {F}^{- 1} ( 1 - {q}_{ij} ) ) - {\sum }_{ijt} {y}_{t} {d}_{ijt} - α {\sum }_{t} {{μ}_{t} ( {\sum }_{i , j \vert i \leq t \leq j} {d}_{ijt} - {c}_{t} )}^{+}$$

such that:

$${\sum }_{t \vert i \leq t \leq j} {d}_{ijt} = {a}_{ij} {q}_{ij} for all i \leq j , \\ {q}_{ij} \geq {q}_{kl} for all i , j , k , l such that i \leq k \leq l \leq j , and$$

$$0 \leq {d}_{ijt} , 0 \leq {q}_{ij} \leq 1 for all i \leq j .$$

This formulation applies the fact that the demand is strictly decreasing in price, hence qᵢⱼ≧qₖₗ if and only if pᵢⱼ≦pₖₗ. The PDM 110 can find the optimal contracts by solving the above optimization problem to obtain the optimal demands (qᵢⱼ). The PDM 110 can then construct the optimal prices using p=F⁻¹(1−q). More specifically, the above optimization problem for the per-contract pricing scheme becomes a convex optimization problem which can be solved using convex optimization tools (in polynomial time) if the function g(q)=u_{ijα}(F⁻¹(1−q)) is concave.

More specifically, according to one technique, the solving module 506 of FIG. 5 can resort to mathematical programming techniques to solve an optimization problem based on the objective function 504. For example, consider the above-described case of the per-contract pricing mechanism for the case in which α=1 (which corresponds to the case of revenue maximization). In certain cases, the demand can be modeled by a stock demand function, for which solutions exist. For example, consider the cases in which the demand function d=1−F(p) satisfies d=a−bp, d=exp(a−bp), or d=ap^{-b} for some constants a and b. In these situations, in can be shown that the function g(q)=u_{ijα}(F⁻¹(1−q)) is concave. Hence, for the purpose of revenue maximization, the PDM 110 can solve the above-described demand-based formulation of the optimization problem using computationally efficient methods (providing, for instance, that the demand can be modeled by a stock demand function for which a solution exists).

The optimization problem can also be solved using a dynamic programming technique. For example, Section B (below) describes one dynamic programming approach that can be used to solve the optimization problem for the per-instance pricing mechanism, for both the hard capacity constraint scenario and the soft capacity constraint scenario. As will be described there, a dynamic programming technique solves the optimization problem in piecemeal fashion by successively breaking the problem into smaller pieces. In such a case, the PDM 110 can perform processing on one piece in a manner that is decoupled from its processing on other pieces.

B. Illustrative Processes

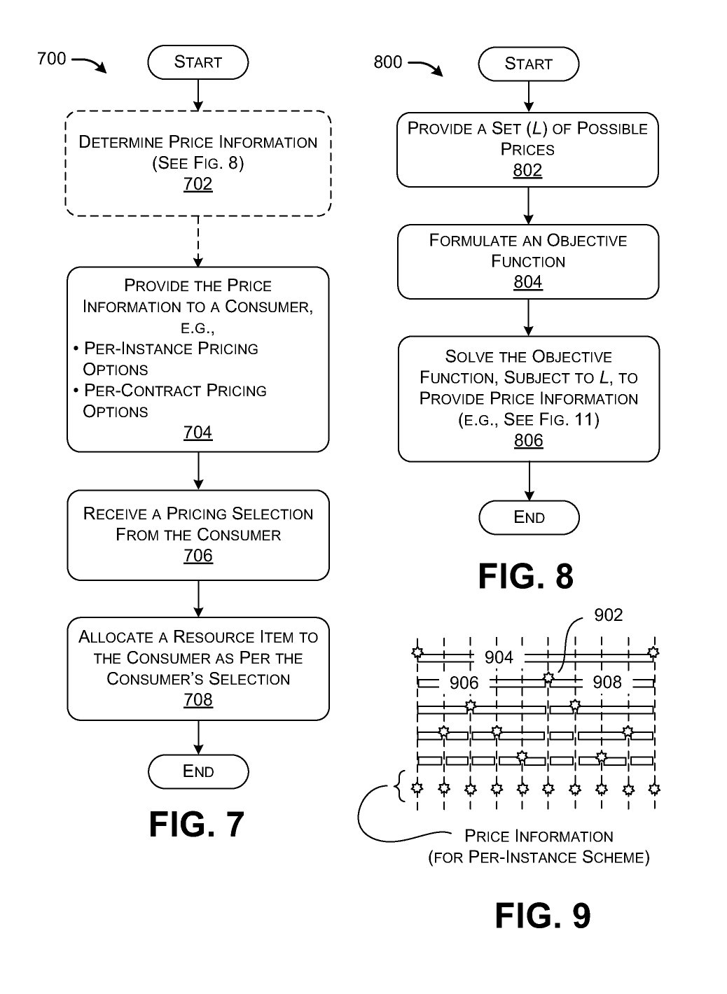

FIGS. 7, 8, 11 and 12 show procedures that explain the operation of the task management module (TMM) 108 of FIG. 1 in flowchart form. Since the principles underlying the operation of the environment 100 have already been described in Section A, some operations will be addressed in summary fashion in this section.

Starting with FIG. 7, this figure shows a procedure 700 that represents an overview of the one manner of operation of the TMM 108 of FIG. 1. In operation 702, the TMM 108 determines price information based on a pricing scheme, such as the per-instance pricing scheme (shown in FIG. 3) or the per-contract pricing scheme (shown in FIG. 4). In operation 704, the TMM 108 forwards the pricing information to the consumers. This may entail sending per-instance pricing options or per-contract pricing options to the consumers.

In operation 706, the TMM 108 receives selections of options made by the consumers, referred to herein as pricing selections. In operation 708, the TMM 108 allocates resource items to the consumers in accordance with their pricing selections.

FIG. 8 shows a procedure 800 which presents additional illustrative details regarding operation 702 of FIG. 7. In operation 802, the PDM 110 provides a set of possible prices (in a manner to be described below). The possible prices describe prices that are deemed possible in view of various constraints that may be imposed on the provider (such as capacity constraints). In operation 804, the PDM 110 formulates an objective function, such as one of the objective functions described above in Section A which expresses utility as a weighted combination of consumer welfare and provider revenue. In operation 806, the PDM 110 solves an optimization problem that is formulated using the objective function, using any type of solving technique.

In one approach, as set forth in Section A, the PDM 110 can use a mathematical programming technique to solve the optimization problem. In another approach, the PDM 110 can use a dynamic programming technique to solve the optimization problem. The following description sets forth one possible dynamic programming technique that can be used. In particular, the PDM 110 uses the following dynamic programming technique to solve an optimization problem associated with the per-instance pricing scheme, for both the case of hard capacity constraints and soft capacity constraints.

FIG. 9 provides high-level introductory information regarding the dynamic programming technique. Generally stated, the PDM 110 operates by identifying a partition point 902 within an entire time segment 904. The PDM 110 then identifies two sub-segments (906, 908) having a common endpoint defined by the partition point 902. The PDM 110 then identifies partition points in each of the sub-segments (906, 908). The PDM 110 repeats this procedure until it has identified partition points correspond to all of the time instances in the entire time segment 904. Each time the PDM 110 defines a partition point, it also defines a price within the final price information. Hence, generally stated, the PDM 110 successively defines the prices by successively dividing the entire time segment 904 into sub-segments.

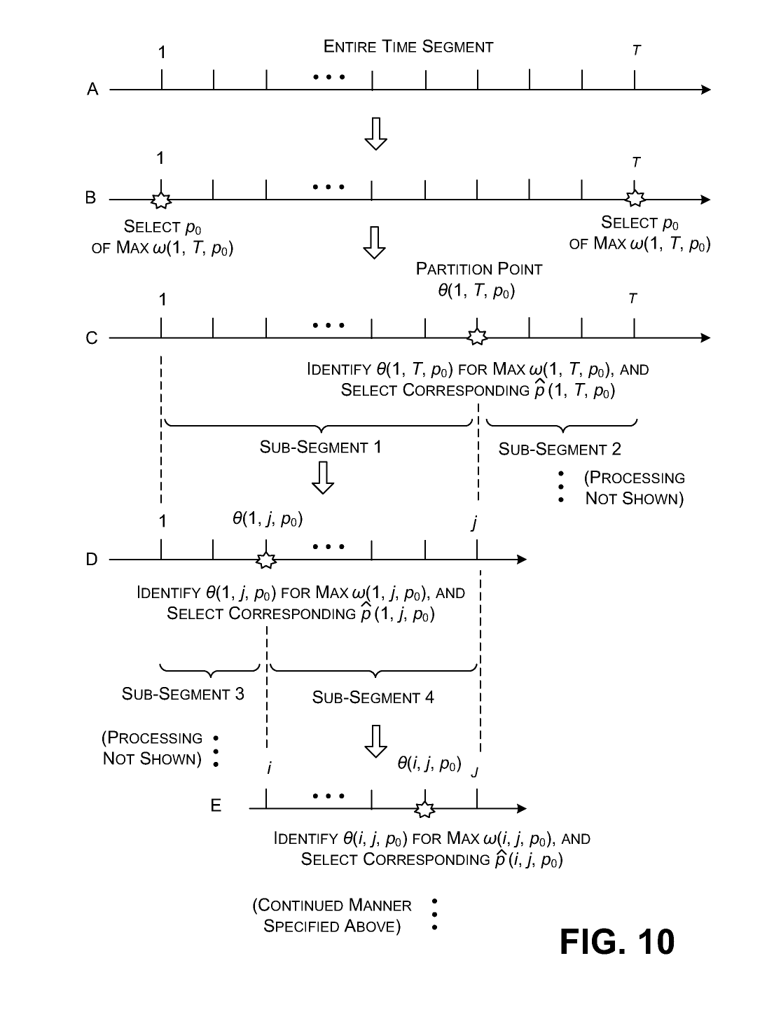

FIG. 10 provides additional details regarding the above-described manner of operation. Each row in FIG. 10 corresponds to a different stage in processing performed by the PDM 110. In row A, the PDM 110 starts with an undivided entire time segment corresponding to an entire time horizon, defined by a starting time instance 1 and an ending time instance T. For the purposes of this explanation, assume that each instance corresponds to an interval of a day, and the entire time horizon corresponds to a two-week period. That is, the starting time instance 1 corresponds to a first Monday in the two-week time horizon and the ending time instance T correspond to a second Sunday in the two-week time horizon.

In a first operation, the PDM 110 first defines a set of possible prices L. The PDM 110 chooses from the set of possible prices when constructing the pricing information. Consider first the case of the per-instance pricing scheme subject to hard constraints. For all tuples (i, j, k) such that i≦k≦j, the set of feasible prices, Pᵢⱼₖ, equals {p|Σₗ₌ᵢ^{k}Σₘ₌ₖ^{j}aₗₘ(1−Fₗₘ(p))≦cₖ}. For the case of soft capacity constraints, the set of possible prices L is not limited by capacity; hence, the PDM 110 does not define the above-described set of capacity-limited feasible prices (Pᵢⱼₖ).

Next, the PDM 110 can formulate an optimization problem. For the case of a hard capacity constraint, the optimization problem can be expressed as:

$$ω ( i , j , {p}_{0} ) = {max}_{k ∈ \{ i , … j \}} {max}_{\{ p > {p}_{o} \vert p ∈ L ⋂ {𝒫}_{ijk} \}} ω ( i , k - 1 , p ) + {\sum }_{l = i}^{k} {\sum }_{m = k}^{j} {a}_{l m} ( {u}_{l m α} ( p ) - α {y}_{t} ( 1 - {F}_{l m} ( p ) ) + ω ( k + 1 , j , p ) .$$

For the case of a soft capacity constraint, the optimization problem can be expressed as:

$$ω ( i , j , {p}_{0} ) = {max}_{k ∈ \{ i , … j \}} {max}_{\{ p > {p}_{0} \vert p ∈ L \}} ω ( i , k - 1 , p ) + {\sum }_{l = i}^{k} {\sum }_{m = k}^{j} {a}_{l m} ( {u}_{l m α} ( p ) - α {γ}_{k} ( 1 - {F}_{l m} ( p ) ) - α {{μ}_{k} ( ( {\sum }_{l = i}^{k} {\sum }_{m = k}^{j} {a}_{l m} ( 1 - {F}_{l m} ( p ) ) ) - {c}_{k} )}^{+} + ω ( k + 1 , j , p ) .$$

In both cases, the optimization problem defines the utility of the environment 100 as a function of two variables that can manipulated in the process of maximizing the utility, namely, variable p and variable k. The variable p corresponds to price. The variable k represents a time instance that occurs within a time segment defined by ij.

The PDM 110 generally operates by finding a position k at which utility is maximized. More specifically, in the case in which plural k's will suffice to solve the optimization problem, the PDM 110 chooses the minimum k within the time segment ij that solves the optimization problem. Then, the PDM 110 finds a price that is associated with the position k. More specifically, in the case in which plural prices will suffice to solve the optimization problem, the PDM 110 chooses the minimum price (for the position k). The PDM 110 performs all these operations subject to a minimum price, p₀. This means that the solving technique is restricted to finding a price that solves the optimization problem that is above the minimum price p₀.

In the notation used herein, the maximum utility within time segment ij (defined by a starting instance i and ending instance j, and subject to minimum price pₒ) is denoted by ω(i, j, p₀). The minimum location that is associated with this maximum utility is denoted by θ(i, j, p₀). In the terminology used herein, θ(i, j, p₀) is also referred to as a partition point insofar as it partitions the time segment ij into sub-segments. And the minimum price that corresponds to the partition point θ(i, j, p₀) is denoted by \hat{p}(i, j, p₀), also referred to as a partition-point price.

In a preliminary operation, the PDM 110 operates by computing ω(i, j, p₀)'s, θ(i, j, p₀)'s, and \hat{p}(i, j, p₀)'s for all combinations of i and j in the entire time interval (1, T), together with all combinations of the minimum price p₀. The PDM 110 can store this information in a data store. In a next phase, the PDM 110 uses the information that it has collected to successively divide the entire time segments into successively smaller segments, and in doing so, define the final prices of the price information.

For example, after defining the ω(i, j, p₀)'s, θ(i, j, p₀)'s, and \hat{p}(i, j, p₀)'s, the PDM 110 begins, as shown in row B of FIG. 10, by defining the minimum price p₀ that yields the maximum utility ω(1, T, p₀) for the entire time segment (1, T). The PDM 110 uses this minimum price p₀ as the price assigned to time instance 1 (e.g., a first Monday) and time instance T (e.g., a second Sunday) in the time horizon. (FIG. 10 represents time instances for which prices have been assigned by stars.)

Next, as shown in row C, the PDM 110 identifies the minimum k for the time segment (1, T) at which the maximum utility occurs, along with the minimum price at that location. In other words, the PDM 110 identifies the partition point θ(1, T, p₀) and the partition-point price \hat{p}(1, T, p₀) that are associated with the maximum ω(1, T, p₀). The PDM 110 uses the partition-point price \hat{p}(1, T, p₀) to define the price of a corresponding time instance in the final price information. For example, assume that the partition point correspond to the second Thursday in the two-week time horizon. The PDM 110 defines the price for the second Thursday to correspond to \hat{p}(1, Tp₀) that occurs at the partition point θ(1, T, p₀).

The PDM 110 then proceeds by identifying two sub-segments, defined by the partition point, referred to in FIG. 10 as sub-segment 1 and sub-segment 2. The PDM 110 then performs the same operations described above with respect to each sub-segment. For example, as illustrated in row D for sub-segment 1 (1, j), the PDM 110 determines the maximum utility ω(1, j, p₀) for the time segment (1, j), identifies the partition point θ(1, j, p₀) associated with the maximum utility, and then identifies the price \hat{p}(1, j, p₀) associated with the partition point. The PDM 110 uses the partition-point price \hat{p}(1, j, p₀) to define the price of another corresponding time instance within the final price information.

The PDM 110 proceeds in the above-described manner for other sub-segments, e.g., by successively identifying partition points and corresponding prices and then dividing the sub-segments into yet smaller sub-segments. The PDM 110 terminates this process when it has defined partition points for each time instance in the original time segment (1, T).

The enabling principle behind the above-described manner of operation is described as follows. A partition point defines a minimum time and a minimum price at which maximum utility can be achieved within a specified time segment ij. Customers in the relevant population who are able to choose this price will therefore not choose a price beyond this partition point, assuming that the consumers are utility maximizers. This, in turn, means that the PDM 110 can decouple further analysis that it performs for the segment prior to the partition point (the prior sub-segment) from the analysis that it performs for the segment after the partition point (the subsequent sub-segment). In other words, this means that the analysis that the PDM 110 performs for the prior sub-segment cannot affect the analysis that it performs for the subsequent sub-segment. This ensues from the very definition of the partition points within the objective function, in conjunction with the utility maximization behavior of the consumers.

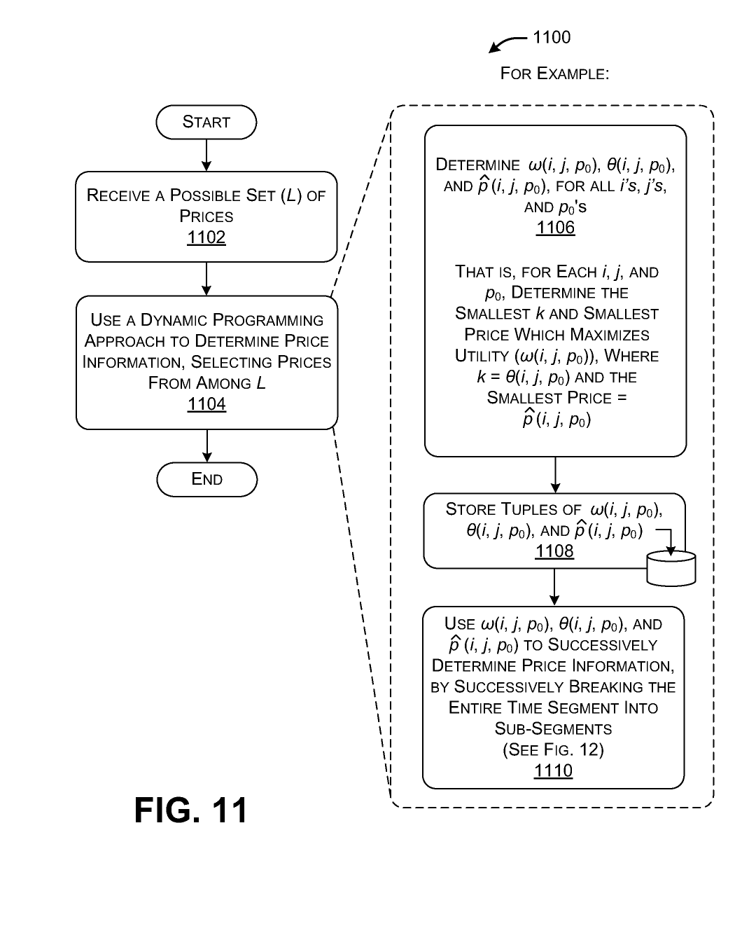

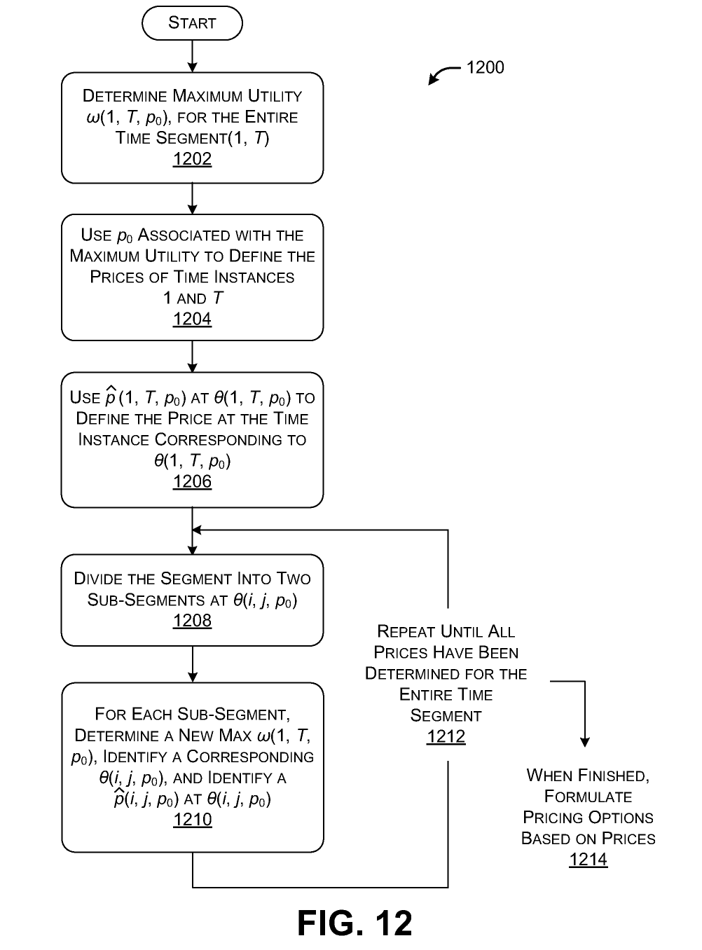

FIGS. 11 and 12 set forth the above-described manner of operation in flowchart form, and thus will be described in summary fashion herein. FIG. 11 shows a procedure 1100 that begins with an overview of the operations. Namely, in operation 1102, the PDM 110 receives a set of possible prices (L). In operation 1104, the PDM 110 uses a dynamic programming technique to define the price information, selecting prices from among the set L.

The right-hand side of FIG. 11 provides additional details regarding the dynamic programming technique. Namely, in operation 1106, the PDM 110 determines various ω(i, j, p₀)'s, θ(i, j, p₀)'s, and \hat{p}(i, j, p₀)'s for different combinations of i and j, and for different p₀'s. Still more specifically, for each i, j, and p₀, the PDM 110 determines the smallest k and smallest price which maximixes utility (ω(i, j, p₀)). The smallest k defines the partition point θ(i, j, p₀). And the smallest price at k defines the partition-point price \hat{p}(i, j, p₀). In operation 1108, the PDM 110 stores the tuple (ω(i, j, p₀), θ(i, j, p₀) and \hat{p}(i, j, p₀)) for each combination of i, j, and p₀. In operation 1110, the PDM 110 uses the stored tuples to successively determine price information by successively breaking the entire time segment into smaller sub-segments (as demonstrated in the example of FIG. 10).

FIG. 12 shows a procedure 1200 that presents yet further information regarding operation 1110 of FIG. 11. This description correlates with the example shown in FIG. 10.

In operation 1202, the PDM 110 determines the maximum utility ω(i, j, p₀) for the entire time segment (1, T). In operation 1204, the PDM 110 selects the minimum price p₀ to define the price for time instance 1 and time instance T of the entire time segment (1, T). In operation 1204, the PDM 110 then identifies the partition point θ(i, j, p₀) associated with the maximum utility (ω(i, j, p₀)). The PDM 110 uses the price \hat{p}(i, j, p₀) that is associated with this partition point as the price of the time instance that corresponds to the partition point.

In operation 1208, the PDM 110 divides the time segment into two sub-segments, based on the partition point θ(i, j, p₀). In operation 1210, for each sub-segment, the PDM 110 determines a new maximum utility ω(i, j, p₀), a new corresponding partition point, and a new corresponding partition-point price \hat{p}(i, j, p₀). The PDM 110 uses this price \hat{p}(i, j, p₀) as a price for a corresponding instance within the final price information.

Operation 1212 indicates that the operations 1208 and 1210 are repeated until the PDM 110 has defined all of the prices in the price information. In operation 1214, the PDM 110 formulates pricing options based on the prices determined in operation 1212.

As a final topic, the PDM 110 (of FIG. 5), and, in particular, the price set determination module 508, can use various techniques to determine the set L of possible prices. The PDM 110 chooses from among these prices in generating pricing options for the consumers' consideration. In one case, the PDM 110 can obtain a set of optimal prices to define the set L, potentially subject to one or more constraints placed on the provider (such as capacity constraints, if relevant). In another case, the PDM 110 cannot determine optimal prices. But the PDM 110 can generate near-optimal prices; those near-optimal prices closely approximate the optimal solution.

For instance, assume that the objective function is continuous. The PDM 110 can select discrete prices from a space of possible prices in the following manner:

$$L = \{ p \vert p = k \frac{ε}{Tl} , for k ∈ \{ 0 , … , \frac{lT}{ε} \} \}$$

The term p refers to a price in the space of possible prices. The term k is a multiplier. The term ∈ refers to an arbitrarily small number. The term T refers to the size of the time horizon, e.g., corresponding to the last time instance in the time horizon. And the term l refers to a relevant constant of the objective function, such as the Lipschitz constant, which is assumed to be known.

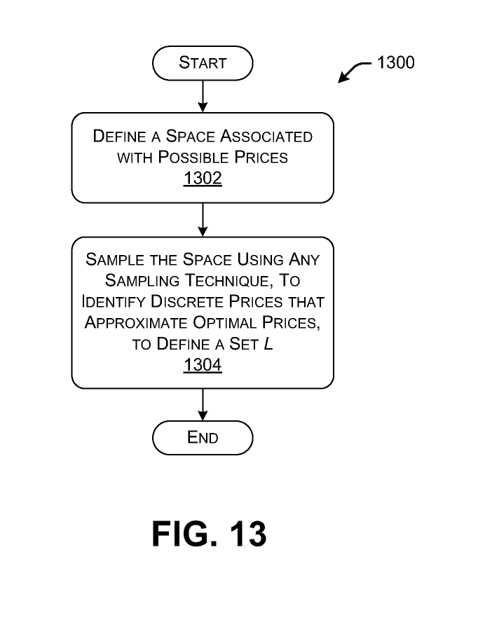

FIG. 13 shows a procedure 1300 which summarizes the above description. In operation 1302, the PDM 110 defines a space associated with possible prices. In operation 1304, the PDM 110 uses any sampling technique to select discrete prices from within the space. The prices closely approximate optimal prices.

C. Representative Computer Processing Functionality

FIG. 14 sets forth illustrative electrical computer processing functionality 1400 that can be used to implement any aspect of the functions described above. With reference to FIG. 1, for instance, the type of processing functionality 1400 shown in FIG. 14 can be used to implement any aspect of task management module (TMM) 108, any aspect of the provider 102, and/or any aspect of a user device operated by a consumer. In one case, the processing functionality 1400 may correspond to any type of computing device that includes one or more processing devices.

The processing functionality 1400 can include volatile and non-volatile memory, such as RAM 1402 and ROM 1404, as well as one or more processing devices 1406. The processing functionality 1400 also optionally includes various media devices 1408, such as a hard disk module, an optical disk module, and so forth. The processing functionality 1400 can perform various operations identified above when the processing device(s) 1406 executes instructions that are maintained by memory (e.g., RAM 1402, ROM 1404, or elsewhere). More generally, instructions and other information can be stored on any computer readable medium 1410, including, but not limited to, static memory storage devices, magnetic storage devices, optical storage devices, and so on. The term computer readable medium also encompasses plural storage devices.

The processing functionality 1400 also includes an input/output module 1412 for receiving various inputs (via input modules 1414), and for providing various outputs (via output modules). One particular output mechanism may include a presentation module 1416 and an associated graphical user interface (GUI) 1418. The processing functionality 1400 can also include one or more network interfaces 1420 for exchanging data with other devices via one or more communication conduits 1422. One or more communication buses 1424 communicatively couple the above-described components together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, using computer processing functionality, for determining price information for perishable resource items, comprising:
providing an objective function which defines utility as a function of price, the objective function comprising a weighted combination of a welfare component and a revenue component, the welfare component defining a benefit conferred to a group of consumers of resource items and the revenue component defining a benefit conferred to a provider of the resource items;
solving an optimization problem that is formulated based on the objective function, using the computer processing functionality, to provide price information, the price information providing a plurality of pricing options;
providing the price information to a consumer;
receiving a selection of a pricing option from the consumer, to provide a pricing selection; and
physically allocating a resource item to the consumer in a manner governed by the pricing selection made by the consumer.

2. The method of claim 1, wherein the resource items comprise physical goods.

3. The method of claim 1, wherein the resource items comprise services.

4. The method of claim 3, wherein the services comprise computational services provided by a data center.

5. The method of claim 1, wherein the objective function provides a parameter that defines an extent of influence of the welfare component and an extent of influence of the revenue component.

6. The method of claim 1, wherein said solving is subject to variable supply of the resource items and variable demand for the resource items.

7. The method of claim 1, wherein the price information that is provided to the consumer comprises a plurality of per-instance prices corresponding to a respective plurality of time instances, each per-instance price defining a cost for providing the resource item in a corresponding time instance.

8. The method of claim 1, wherein the price information that is provided to the consumer comprises a plurality of per-contract prices corresponding to a plurality of time segments, each time segment defining a time at which a task associated with the resource item is submitted and a time at which the resource item is to be delivered, and each per-contract price defining a cost for providing the resource item according to a corresponding time segment.

9. The method of claim 1, wherein said objective function is defined with respect to a hard capacity constraint which specifies that a capacity of resource items is not to be exceeded.

10. The method of claim 1, wherein the objective function is defined with respect to a soft capacity constraint which specifies that a capacity of resource items can be exceeded, but exceeding the capacity incurs an increased cost.

11. The method of claim 1, wherein said solving involves using a mathematical programming technique to solve the optimization problem.

12. The method of claim 1, wherein said solving involves using a dynamic programming technique to solve the optimization problem.

13. The method of claim 12, wherein the dynamic programming technique involves successively breaking down an initial time segment into different sub-segments to successively identify the pricing options in the pricing information.

14. The method of claim 12, wherein the dynamic programming technique involves successively performing operations of:
determining a maximum utility associated with a time segment ij, subject to a minimum price p₀, the time segment ij being defined by a starting time instance i and an ending time instance j;
identifying a partition point within the time segment ij, the partition point corresponding to a minimum time instance which solves the optimization problem and yields the maximum utility;
identifying a pricing option based on a partition-point price associated with the partition point; and
repeating the operations with respect to sub-segments defined by the partition point.

15. A task management module, implemented by computer processing functionality, for use in determining price information that defines prices of computational resource items, comprising:
a price determination module configured to solve an optimization problem that is formulated based on an objective function, to provide price information, the price information defining a plurality of pricing options for consideration by consumers; and
a resource allocation module configured to allocate a computational resource item to a consumer in a manner governed by a pricing option selected by that consumer.

16. The task management module of claim 15, wherein the price information comprises a plurality of per-instance prices corresponding to a respective plurality of time instances, each per-instance price defining a cost for providing the resource item in a corresponding time instance.

17. The task management module of claim 15, wherein the price information comprises a plurality of per-contract prices corresponding to a plurality of time segments, each time segment defining a time at which a task associated with the resource item is submitted and a time at which the resource item is to be delivered, and each per-contract price defining a cost for providing the resource item according to a corresponding time segment.

18. The task management module of claim 15, wherein the price determination module is configured to select the pricing options from among a set of possible prices.

19. The task management module of claim 18, further comprising a price set determination module configured to determine the set of possible prices by selecting discrete samples from a pricing space.

20. A computer readable medium for storing computer readable instructions, the computer readable instructions providing a price determination module when executed by one or more processing devices, the computer readable instructions comprising:
logic configured to solve an optimization problem that is formulated based on an objective function, to identify a maximum utility associated with a time segment ij, subject to a minimum price p₀, where i defines a starting time instance and j defines an ending time instance;
logic configured to identify a partition point within the time segment ij, the partition point corresponding to a minimum time instance which solves the optimization problem and yields the maximum utility; and
logic configured to identify a pricing option associated with the partition point, a collection of pricing options defining pricing information,
the objective function defining utility as a function of price, the objective function further comprising a weighted combination of a welfare component and a revenue component, the welfare component defining a benefit conferred to a group of consumers of resource items and the revenue component defining a benefit conferred to a provider of the resource items.
